(19) United States
(12) Patent Application Publication
(10) Pub. No.: US 2007/0140165 A1
(43) Pub. Date: Jun. 21, 2007

(54) Base station uplink scheduler in wireless communication system and method thereof

(75) Inventors: Eun-Kyung Kim, Daejeon-city (KR); Ju-Hee Kim, Daejeon-city (KR); Kyung-Soo Kim, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Tesearch Institute, Daejeon (KR); KT Corporation, Seongnam-city (KR); SK TELECOM CO., LTD., Seoul (KR); HANARO TELECOM., INC., Seoul (KR)

(21) Appl. No.: 11/604,980

(22) Filed: Nov. 28, 2006

(30) Foreign Application Priority Data
Nov. 28, 2005 (KR) 10-2005-0114133

(51) Int. Cl. H04Q 7/00

(52) U.S. Cl. 370/329; 370/338

(57) ABSTRACT

A method of an uplink scheduler for a base station in a wireless communication system is provided. The wireless communication system performs uplink wireless access for a best effort service, based on random access. The uplink scheduler of the base station transmits downlink traffic data to a user terminal, and estimates uplink traffic data generated from the user terminal based on the downlink traffic data. In addition, the uplink scheduler allocates resources for the estimated uplink traffic data to the user terminal, and receives the uplink traffic data transmitted from the user terminal by using the resources allocated to the user terminal.

### PRIORITY

This application claims priority to Korean Patent Application No. 10-2005-0114133 filed in the Korean Intellectual Property Office on Nov. 28, 2005, the contents of which are incorporated herein by reference.

### BACKGROUND OF THE INVENTION

1. Field of the Invention

The present invention relates to a scheduler of an access point in a wireless communication system, and more particularly, relates to a device for performing an uplink scheduling operation of an access point in a wireless communication system, and a method thereof.

2. Description of the Related Art

An IEEE 802.16 wireless Metropolitan Area Network (MAN)-based high-speed portable Internet system is a 3.5^{th} generation mobile communication system, in which high-speed packet data including Internet Protocol (IP)-based wireless data services (e.g., a streaming video service, file transfer protocol (FTP) service, mail service, and chatting service) are provided by using a wire transmission scheme for guaranteeing spectrum efficiency in the 2.3 GHz frequency bandwidth.

The portable Internet system performs uplink wireless access for best effort service, based on random access. Accordingly, when a downlink transmission control protocol (TCP) traffic from an access point (AP) to an access terminal (AT) occurs, the AT transmits an acknowledgement (ACK) message for a received TCP packet to the AP by performing the wireless random access scheme. In this case, the round trip time is problematically increased, and therefore, the speed may be reduced in the portable Internet network.

### SUMMARY OF THE INVENTION

The present invention provides an uplink scheduler for solving the round trip time (RTT) increase problem caused by the wireless access of best effort service, and improved network speed when a base station of a wireless communication system performs uplink scheduling.

A preferred uplink scheduler of a base station in a wireless communication system according to the present invention includes an uplink traffic generation estimating unit and an uplink traffic resource allocating unit. The uplink traffic generation estimating unit estimates uplink traffic data to be generated from the user terminal after downlink traffic data are transmitted to a user terminal. The uplink traffic resource allocating unit performs uplink scheduling to allocate unicast uplink resources for the uplink traffic estimated by the uplink traffic generation estimating unit.

In a preferred uplink scheduling method for performing uplink scheduling in a base station of a wireless communication system according to the present invention, downlink traffic data are transmitted to a user terminal; uplink traffic data generated from the user terminal are estimated based on the downlink traffic data; resources for the estimated uplink traffic data are allocated to the user terminal; and the uplink traffic data transmitted from the user terminal are received by using the resources allocated to the user terminal.

### BRIEF DESCRIPTION OF THE DRAWINGS

The above and other objects, features and advantages of the present invention will become more apparent from the following detailed description of the preferred embodiments of the present invention, taken in conjunction with the accompanying drawings in which:

FIG. 1 shows a diagram of a wireless frame configuration of a conventional portable Internet system (e.g., a wireless broadband (WiBro) internet system);

FIG. 2 shows the configuration of a conventional transmission control protocol (TCP)/Internet protocol (IP) packet;

FIG. 3 shows a flow diagram representing a conventional TCP data flow;

FIG. 4 shows a flow diagram of a TCP/IP service in the conventional portable Internet system; FIG. 5 shows a system diagram of a portable Internet system according to the present invention;

FIG. 6 shows a flow diagram representing a TCP/IP service according to the present invention.

FIG. 7 shows a flow diagram representing an operation of a scheduler of an access point according to the present invention.

### DETAILED DESCRIPTION OF THE PREFERRED EMBODIMENTS

The present invention will be described more fully hereinafter with reference to the accompanying drawings, in which preferred embodiments of the invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

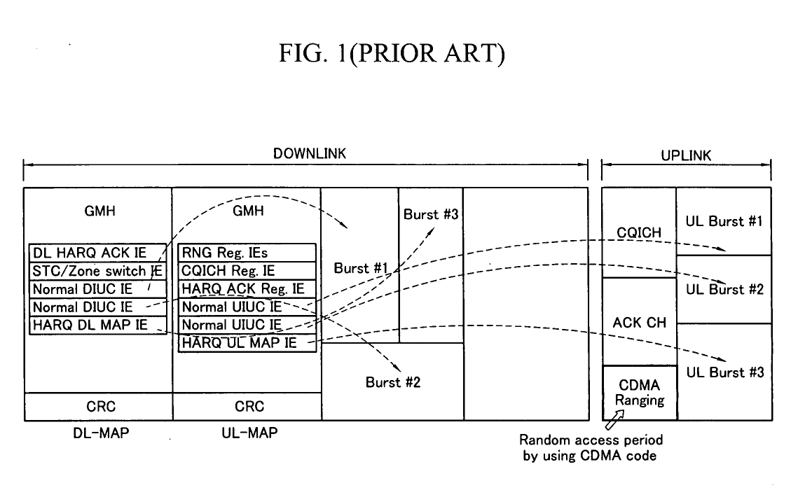

Referring to FIG. 1, in Orthogonal Frequency Division Multiplexing (OFDM)/Frequency Division Multiple Access (FDMA)/Time Division Duplexing (TDD) schemes, a subchannel including subcarrier groups is used to transmit and receive data. A wireless frame of the portable Internet system includes a downlink frame and an uplink frame. For each frame, the portable Internet system adds a map (MAP) message including frame configuration information to a former part of the frame, transmits the MAP message, and subsequently transmits a data burst. Accordingly, a base station scheduler allocates a subchannel to be used to transmit respective user data for each frame, and forms the MAP message.

The MAP message includes a downlink (DL)-MAP for downlink traffic and an uplink (UL)-MAP for uplink traffic, and the respective MAPs include an information element (IE) and a cyclic redundancy check (CRC) for informing generic medium access control (MAC) header (GMH) and the data burst. The IE determines a region of data, and stores information for each region.

Among the IEs, a normal DL Interval Usage Code (DIUC) IE, a Hybrid Automatic Repeat reQuest (HARQ) DL MAP IE, a normal UL Interval Usage Code (UIUC) IE, a HARQ UL MAP IE are based on the information of the data burst, and include information of an access terminal (AT).

The UL frame includes a Channel Quality Information CHannel (CQICH), an Acknowledgement CHannel (ACKCH), and a Code Division Multiple Access (CDMA) ranging channel. The CDMA ranging channel is used to perform a random access by using a CDMA code. The CQICH is used to perform an adaptive modulation operation. The ACKCH is ACK information for the HARQ.

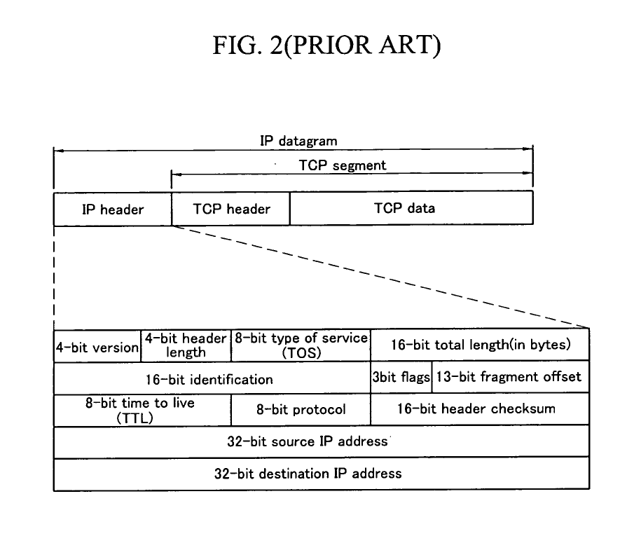

Referring to FIG. 2, an IP datagram includes an IP header and a TCP segment, and the TCP segment includes a TCP header and TCP data.

In Internet Protocol version 4 (IPv4) header configuration, the IP datagram includes a 4-bit version field indicating a version number of the IP protocol, a 4-bit length field for indicating a length of the IP header, a 8-bit type of service (TOS), a 16-bit total length, a 16-bit identifier field, a 3-bit flag field, a 13-bit fragment offset field used to reassemble fragmented packets, an 8-bit time to live (TTL) field for indicating the lifespan of the datagram in the network, an 8-bit protocol field for indicating the protocol of a higher IP layer, a 16-bit header checksum field, a 32-bit source IP address field, and a 32-bit destination IP address field.

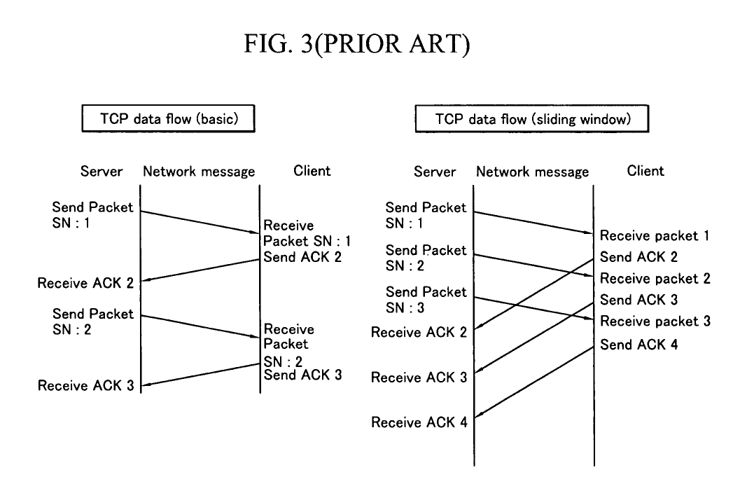

Referring to FIG. 3, in the portable Internet system, when a conventional Web service (e.g., a best effort service) is provided, the TCP/IP is used as a transmission layer. In the TCP, bi-directional traffic is continuously generated. The best effort service is mostly formed based on TCP/IP.

As shown in FIG. 3, a server transmits a packet to a client based sequence numbers (SN1, SN2, SN3, and . . . SNn) by a basic method or a sliding window protocol. The client transmits an ACK message to the server in response to the received packet, and finishes one TCP data transmission process.

That is, when downlink TCP traffic from an AP to an AT occurs, the AT receiving the TCP packet transmits the ACK message for the received packet to the AP and finishes the TCP data transmission process. In this case, the TCP packet may be segmented into a plurality of packets. The divided packets are transmitted by determining a segmentation order and a segmentation state by the IP header shown in FIG. 2. When the TCP packet is segmented, the ACK message is transmitted after the last packet among the segmented packets. In further detail, a 3-bit flag of the IP header includes three fields including reserved, D, and M fields. When the M field is set to be 0, the AT acknowledges that the segment is the last one, and transmits the TCP ACK message.

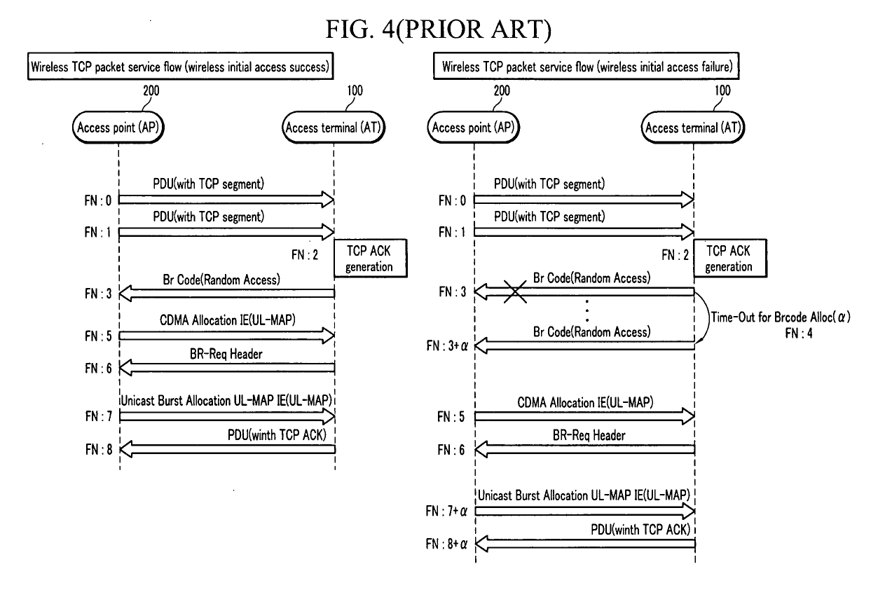

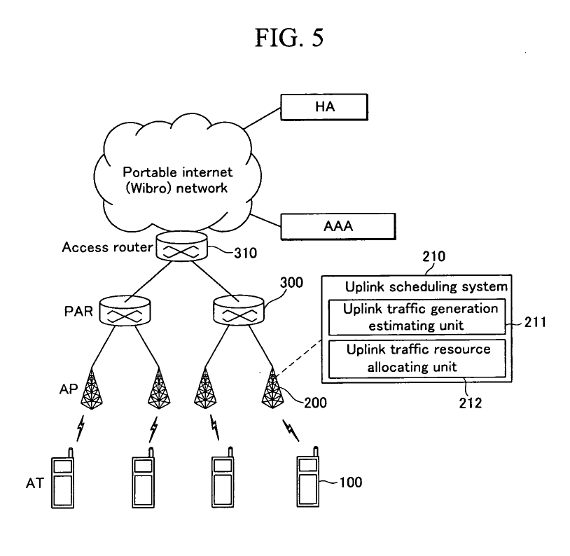

Referring to FIG. 4, when the AP successfully transmits the TCP packet to the AT, the AT transmits the ACK message to the access point (AP) in response to the TCP packet, and prepares to receive a subsequent TCP packet or transmits a subsequent ACK message.

As shown in FIG. 4, when the AP transmits data to the AT, a packet data unit (PDU) with TCP segment (FN:0 and FN:1) is transmitted. In this case, when detecting the last segmentation of the transmitted packet data unit, the AT generates a TCP ACK message, and tries to perform the wireless random access (FN:3) to the AP.

When the wireless initial access fails, the AT repeatedly performs the wireless random access (FN:3−FN:3+α) until it is successfully performed. In this case, the AT performs the random access (FN:4) within a time-out range to allocate a Br-code (Bandwidth Request-code) when performing a bandwidth request from the AP.

When the AT successfully accesses the AP through the wireless random access, the AP transmits CDMA allocation IE data to the AT by using an UL-MAP message (FN:5). The AT transmits a bandwidth request allocation header (BR-Req Header) to the AP (FN:6), and receives resources.

The AP receiving the bandwidth request allocation header (BR-Req Header) transmits a unicast burst allocation data to the AT by using the UL-MAP message (FN:7), and receives resources. The AT transmits the previously generated TCP ACK message to the AP (FN:8), and finishes transmitting the TCP packet. In this case, since a process for receiving the bandwidth for transmitting the ACK message after generating the ACK message for the TCP packet is repeatedly performed in the wireless access link, a round trip time (RTT) is increased, and speed is reduced in a network. Accordingly, when the AT fails to perform the initial wireless access to the AP, the network speed may be further reduced.

As shown in FIG. 5, the portable Internet system includes an AT 100, an AP 200 for supporting a wireless access between the ATs 100, a packet access router (PAR) 300 for performing mobility control and packet routing functions of the respective ATs, and an access router 310.

To support high-speed packet data transmission in a wireless link, the portable Internet system (e.g., a wireless broadband (WiBro) Internet system) according to the present invention transmits/receives data for each frame, and uses Orthogonal Frequency Division Multiplexing (OFDM)/Frequency Division Multiple Access (FDMA)/Time Division Duplexing (TDD) schemes.

A traffic process of AP 200 of the portable Internet system includes a downlink (forward) scheduling function for processing downlink traffic from AP 200 to AT 100, and an uplink (reverse) scheduling function for processing uplink traffic from AT 100 to AP 200.

An uplink scheduling system 210 for improving the speed for transmitting the best effort service by AP 200 includes an uplink traffic generation estimating unit 211, and an uplink traffic resource allocating unit 212.

To prevent the RTT from being increased and the network speed from being reduced when the packet data are transmitted and received between AP 200 and AT 100, uplink traffic generation estimating unit 211 estimates uplink traffic generation from AT 200 to AP 200 after providing the downlink TCP traffic service from AP 200 to AT 100.

Uplink traffic generation estimating unit 211 estimates the uplink traffic generation while expecting that AT 100 directly transmits an uplink traffic or uplink traffic allocation request message after the downlink traffic service. The uplink traffic may be the initial access Br-code for performing the random access, and it includes an uplink traffic allocation request header and unicast uplink resource allocation data for the TCP-ACK message.

Uplink traffic resource allocating unit 212 does not perform the wireless random access, and allocates unicast uplink resources (e.g., a bandwidth) to corresponding AT 100 during a time period calculated to directly transmit the uplink traffic message or the uplink traffic allocation request message.

Uplink traffic resource allocating unit 212 allocates the unicast uplink resources to the AT that is expected to allocate resources through the uplink traffic allocation request header and is expected to generate the uplink traffic, in which an allocation range does not excess a total of the ATs.

When the uplink traffic is greater than a reference, uplink traffic resource allocating unit 212 allocates the resources for the uplink traffic allocation request header (Br-Req Header). When the resources may be additionally allocated, the resources for the TCP-ACK are allocated.

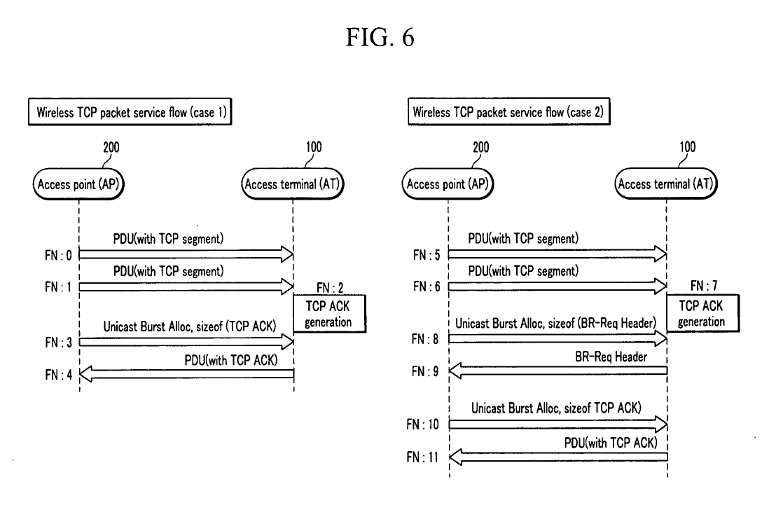

Referring to FIG. 6, AP 200 starts the best effort service, generates the downlink TCP traffic, segments the TCP packet data units (i.e., the PDU with TCP segment), and transmits them to corresponding AT 100 (FN0 to FN1 and FN5 to FN6). Subsequently, AT 100 generates the TCP ACK message when detecting the last segmentation of the TCP packet (FN:2 and FN:7).

When there are sufficient resources (bandwidth) to be allocated by AP 200 (shown in a case 1 in FIG. 6), AT 100 generates the TCP ACK message (FN:2), and AP 200 allocates the unicast burst resources corresponding to the TCP ACK message to AT 100 (FN:3). The corresponding AT 100 transmits the TCP ACK packet (PDU with TCP ACK) to AP 200, and finishes the TCP transmission process (FN:4).

When there are not enough resources to be allocated (shown in case 2 in FIG. 6), AT 100 generates the TCP ACK message (FN:7). AP 200 allocates the resources corresponding to the uplink resource allocation header to the unicast burst (Unicast Burst Alloc) (FN:8). AT 100 transmits the uplink resource allocation header (BR-Req Header) to AP 200 (FN:9), and requests the resources corresponding to the TCP ACK message.

AP 200 receiving the uplink resource allocation request allocates the unicast burst resources corresponding to the TCP ACK message to corresponding AT 100, and transmits the TCP ACK packet (PDU with TCP ACK) (FN:11).

In this case, AP 200 uses one list AuxiliaryBrList to manage information of the AT that is expected to generate the uplink traffic by uplink traffic generation estimating unit 211 after providing the downlink TCP traffic service, and the list is used to allocate the wireless resources.

Referring to case 1 shown in FIG. 6, when there are enough resources (e.g., the bandwidth) to be allocated, the processes for performing the random access and allocating the resources through the uplink allocation header (Br_Requ header) after transmitting the CDMA Allocation IE are omitted. After estimating the uplink traffic generation and transmitting the last part of the TCP segment, uplink traffic generation estimating unit 211 of AP 200 receives the TCP ACK message from AT 100 and allocates the resources corresponding to the TCP-ACK. Accordingly, overhead for a middle process may be reduced.

Referring to the case 2 shown in FIG. 6, when there are not enough resources to be allocated, the random access is omitted. That is, the resources corresponding to the TCP-ACK are allocated per the Br-Req header, and the TCP-ACK message is transmitted. In case 1 shown in FIG. 6, the resources (bandwidth) to be allocated from AP 200 are enough. In case 2 shown in FIG. 6, the resources to be allocated from AP 200 are not enough.

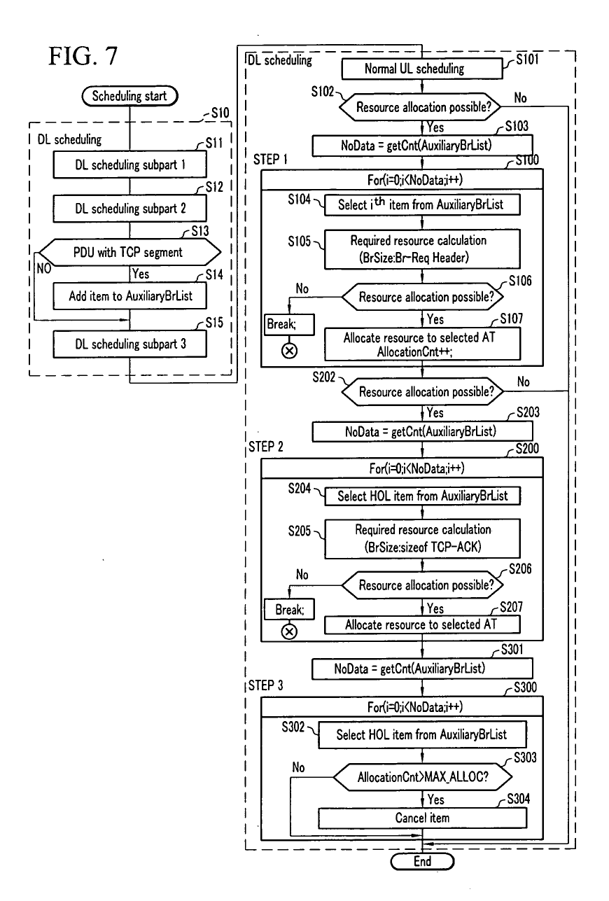

As shown in FIG. 7, when AP 200 transmits the downlink TCP data to the plurality of AT 100, a downlink scheduling is performed for respective subparts SubPart1 and SubPart2 in steps S11 and S12. If there is a packet including the TCP segment (i.e., the PDU with TCP segment) in step S13 when the downlink TCP data are transmitted, information of the corresponding AT is added to the list auxiliaryBrList of the scheduler in step S14, the scheduling operation is performed for a subsequent subpart SubPart3 in step S15.

When the downlink scheduling operation is finished, the scheduler of AP 200 performs an uplink scheduling operation.

In the uplink scheduling operation, after performing a normal uplink scheduling operation, steps STEP1 (S100), STEP2 (S200), and STEP3 (S300) are performed when the resources may be additionally allocated. When the resources are not additionally allocated, the scheduler receives the resources in the method shown in FIG. 4, and transmits the TCP-ACK message.

STEP1 includes sub-steps S101 to S107. The normal scheduling operation is performed in sub-step S101, and it is determined in sub-step S102 if the resources may be additionally allocated. When it is determined that the resources are additionally allocated, the number of lists is detected from the list AuxiliaryBrList of the scheduler in sub-step S103. UL scheduler 210 allocates the resources corresponding to the number of lists (NoData) to AT 100, and selects one item (iₜₕ item) from the list AuxiliaryBrList to calculate the resources (BrSize:Br-Req Header) in sub-steps S104 and S105. When the resources for the uplink resource allocation header Br-Req Header may be allocated in sub-step S106, UL scheduler 210 allocates the resources to the selected AT to increase the number AllocationCnt in sub-step S107. When the resources may not be allocated, the process for allocating the resources is finished. In addition, the above process is repeatedly performed up to the number of the lists (NoData).

STEP2 includes sub-steps S202 to S207. After performing STEP1, when the resources may be additionally allocated in step S202, UL scheduler 210 determines the number of lists from the list AuxiliaryBrList of the scheduler in step S203, and allocates the resources corresponding to the number of lists (NoData). One head of list (HOL) item is selected from the list of the scheduler in step S204, required resources (BrSize: size of TCP-ACK) are calculated in step S205. UL scheduler 210 determines in step S206 whether the resources may be used. When it is determined that the resources corresponding to the TCP ACK message may be allocated, the resources are allocated to the selected AT in sub-step S207. When there is no resource to be allocated, the process is finished. In addition, the above process is repeatedly performed up to the sum of the lists (NoData).

STEP3 includes sub-steps S301 to S304. UL scheduler 210 determines the number of lists from the list AuxiliaryBrList of the scheduler (NoData=getCnt(AuxiliaryBrList) in step S301, the HOL item is selected from the list in step S302. UL scheduler 210 determines in step S303 if the increased number AllocationCnt exceeds the number MAX_ALLOC of the entire allocatable resources. When the number AllocationCnt exceeds the number MAX_ALLOC, item information for the selected AT is canceled from the list AuxiliaryBrList of the scheduler in step S304. In this case, the resources are allocated within a range, in which the increased resource allocation number AllocationCnt does not exceed the entire allocatable resource number.

STEP1 corresponds to case 2 shown in FIG. 6, and STEP2 corresponds to case 1 shown in FIG. 6. The resources corresponding the number of ATs are allocated, and the number is the number MAX_ALLOC.

Accordingly, the uplink (reverse) scheduler for processing the traffic estimates that the uplink traffic is generated from the corresponding AT after generating the downlink TCP traffic is generated from AT 100, and allocates the unicast uplink resources. The corresponding AT does not perform the wireless random access, but directly transmits the uplink traffic message or the uplink traffic allocation request message.

As described above, according to the preferred embodiment of the present invention, the uplink (reverse) scheduler for processing traffic in the AP of the IEEE 802.16 Wireless MAN-based portable Internet system estimates that the uplink traffic is generated from corresponding AT after the downlink TCP traffic is generated from the AT, and allocates the unicast uplink resources. The corresponding AT does not perform the wireless random access, but directly transmits the uplink traffic message or the uplink traffic allocation request message. Accordingly, the problem of RTT may be solved, and the network speed may be increased in the portable Internet system.

While this invention has been described in connection with what is presently considered to be practical preferred embodiments, it is to be understood that the invention is not limited to the disclosed embodiments, but, on the contrary, is intended to cover various modifications and equivalent arrangements included within the spirit and scope of the appended claims.

What is claimed is:

1. An uplink scheduler of a base station in a wireless communication system, the uplink scheduler comprising:
an uplink traffic generation estimating unit for estimating uplink traffic data to be generated by a mobile station after transmitting downlink traffic data to the mobile station; and
an uplink traffic resource allocating unit for performing uplink scheduling allocating unicast uplink resources for the uplink traffic estimated by the uplink traffic generation estimating unit to the mobile station.

2. The uplink scheduler of claim 1, wherein the uplink traffic generation estimating unit estimates that an uplink resource allocation header BR-Req Header for transmitting the uplink traffic or an acknowledgement (ACK) packet is generated from the mobile station after transmitting the downlink traffic data, without depending on wireless random access.

3. The uplink scheduler of claim 1, wherein the uplink traffic generation estimating unit determines an Internet Protocol (IP) header of the transmitted downlink traffic data after transmitting the downlink traffic data to the mobile station, transmits a last segmentation of a Transmission Control Protocol (TCP) packet when the TCP packet is segmented, and estimates uplink traffic data generation.

4. The uplink scheduler of claim 2, wherein the uplink traffic resource allocating unit allocates resources for the ACK packet traffic estimated by the uplink traffic generation estimating unit to the mobile station through a unicast burst allocation message.

5. The uplink scheduler of claim 4, wherein, when the number of resources that may be allocated by the base station is less than the number of the resources required for ACK packet traffic estimated by the uplink traffic generation estimating unit, the uplink traffic resource allocating unit allocates the resources for the resource allocation header estimated by the uplink traffic generation estimating unit.

6. The uplink scheduler of claim 5, wherein the uplink traffic resource allocating unit allocates the resources for the uplink resource allocation header traffic estimated by uplink traffic generation estimating unit to the mobile station through the unicast burst allocation message.

7. An uplink scheduling method for performing uplink scheduling in a base station of a wireless communication system, the method comprising:
transmitting downlink traffic data to a mobile station;
estimating uplink traffic data to be generated by the mobile station based on the downlink traffic data;
allocating resources for the estimated uplink traffic data to the mobile station; and
receiving the uplink traffic data transmitted from the mobile station by using the resources allocated to the mobile station.

8. The uplink scheduling method of claim 7, wherein the estimated uplink traffic data are uplink resource allocation header traffic data or acknowledgement (ACK) packet traffic data.

9. The uplink scheduling method of claim 7, wherein, allocating the resources to the mobile station further comprises:
determining if the number of resources that may be allocated by the base station is greater than the number of resources required for acknowledgement (ACK) packet traffic data among the estimated uplink traffic data;
allocating the resources for the ACK packet traffic when it is determined that the number of resources that may be allocated by the base station is greater than the number of resources required for the ACK packet traffic data; and
allocating the resources for uplink resource allocation header traffic data among the estimated uplink traffic when it is determined that the number of resources that may be allocated by the base station is less than the number of resources required for the ACK packet traffic data.

10. The uplink scheduling method of claim 9, further comprising, after allocating the resources for the uplink resource allocation header traffic data,
receiving a resource allocation request for the ACK packet traffic data from the mobile station; and
allocating the resources for the ACK packet traffic data to the mobile station according to the resource allocation request.

11. The uplink scheduling method of claim 9, wherein the resources for the ACK packet traffic data or the resources for the uplink resource allocation header traffic data are allocated by a unicast burst allocation message.

12. The uplink scheduling method of claim 7, wherein, in the estimating of the uplink traffic data, the Internet Protocol (IP) header of the downlink traffic data transmitted to the mobile station is determined, and a last segmentation of the transmitted Transmission Control Protocol (TCP) packet is transmitted when the TCP packet is segmented, and uplink traffic generation is estimated.
